(19) United States
(12) Patent Application Publication
(10) Pub. No.: US 2008/0166569 A1
(43) Pub. Date: Jul. 10, 2008

(54) PLASTIC GLAZING SYSTEMS HAVING WEATHERABLE COATINGS WITH IMPROVED ABRASION RESISTANCE FOR AUTOMOTIVE WINDOWS

(75) Inventors: Steven M. Gasworth, Novi, MI (US); Sunitha Grandhee, Novi, MI (US); Meng Chen, Novi, MI (US); Mark A. Peters, Kingsport, TN (US)

Correspondence Address: EXATEC;C/O BRINKS HOFER GILSON & LIONE, P. O. BOX 10395, CHICAGO, IL, 60610, US

(73) Assignee: Exatec, L.L.C., Wixom, MI (US)

(21) Appl. No.: 11/960,193

(22) Filed: Dec. 19, 2007

Related U.S. Application Data
(60) Provisional application No. 60/875,837, filed on Dec. 19, 2006.

(51) Int. Cl. B32B 27/40; B05D 5/00

(52) U.S. Cl. 428/423.1; 427/161

(57) ABSTRACT

A plastic glazing system having weatherable coating for automotive windows is disclosed. The system comprises a transparent plastic substrate comprising an inner surface and an outer surface. The system further comprises a first weathering layer disposed on the outer surface of the substrate. The weathering layer comprises one of a polyurethane and a polyurethane-acrylate. The first weathering layer has a predetermined glass transition temperature. The system further comprises a first abrasion-resistant layer disposed on the first weathering layer. The first abrasion-resistant layer is compatible with the one of a polyurethane and a polyurethane-acrylate.

### CROSS-REFERENCE TO RELATED APPLICATIONS

This application claims the benefit of U.S. Provisional Application Ser. No. 60/875,837, filed on Dec. 19, 2006, entitled “PLASTIC GLAZING SYSTEMS HAVING WEATHERABLE COATINGS WITH IMPROVED ABRASION RESISTANCE FOR AUTOMOTIVE WINDOWS,” the entire contents of which are incorporated herein by reference.

### TECHNICAL FIELD

The present invention relates to plastic glazing systems having weatherable coatings with improved abrasion resistance for automotive windows.

### BACKGROUND OF THE INVENTION

For many years, glass has been a component used for windows in the automotive industry. As known, glass provides a level of abrasion resistance and ultraviolet radiation (UV) resistance acceptable to consumers for use as a window in vehicles. Although adequate in that respect, glass substrates are characteristically relatively heavy which translates to high costs in delivery and installment. Moreover, the weight of glass ultimately affects the total weight of the vehicle. Plastic materials have been used in a number of automotive engineering applications to substitute glass, enhance vehicle styling, and lower total vehicle weight and cost. An emerging application for transparent plastic materials is automotive window systems.

There is a need in the industry to formulate glass substitute window systems, such as plastic window systems, that are easier to manufacture and relatively lighter in weight without compromising functionality, such as weatherability, abrasion resistance, and UV resistance.

### BRIEF SUMMARY OF THE INVENTION

The present invention generally provides a plastic glazing system having a weatherable coating with improved abrasion resistance. The plastic glazing system includes a plastic substrate, a weathering layer disposed on the substrate, and an abrasion layer disposed on the weathering layer. In this example, the weathering layer has enhanced abrasion resistance.

In one embodiment, the system comprises a transparent plastic substrate comprising an inner surface and an outer surface. The system further comprises a first weathering layer disposed on the outer surface of the substrate. The weathering layer comprises one of a polyurethane and a polyurethane-acrylate, and has a predetermined glass transition temperature. The system further comprises a first abrasion-resistant layer disposed on the first weathering layer. The first abrasion-resistant layer is compatible with the one of a polyurethane and a polyurethane-acrylate.

Further objects, features, and advantages of the present invention will become apparent from consideration of the following description and the appended claims when taken in connection with the accompanying drawings.

### BRIEF DESCRIPTION OF THE DRAWINGS

FIG. 1 is a cross-sectional view of a plastic glazing system depicted in accordance with one embodiment of the present invention; and

FIG. 2 is a graph of the Modulus (E) exhibited by a polymer system versus Temperature depicting the occurrence of a Glass Transition Temperature (Tg).

### DETAILED DESCRIPTION OF THE INVENTION

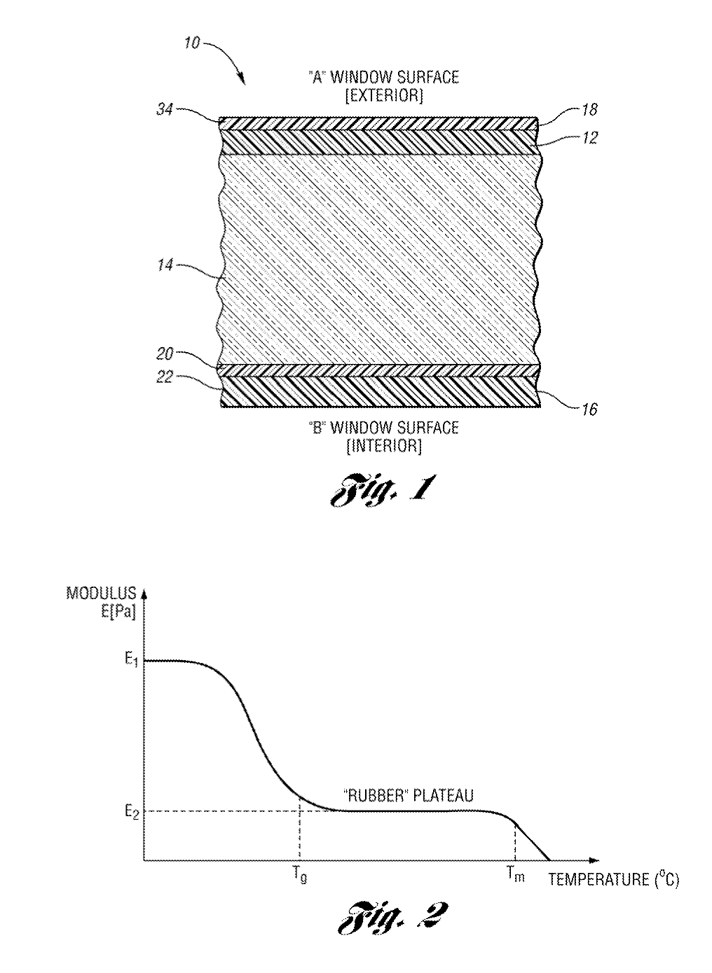

FIG. 1 depicts one example of a cross-section of a plastic glazing system 10. The plastic glazing system 10 is preferably a system for use as an automotive window. As shown, the plastic glazing system 10 includes a transparent plastic substrate 14 having a first or inner surface 16 and a second or outer surface 18. In this embodiment, the second surface 18 is an exterior or “A” surface and the first surface 16 is an interior or “B” surface of the window.

The substrate, according to exemplary embodiments of the invention, preferably comprises a polymer resin. In one embodiment, the transparent plastic substrate 14 generally comprises polycarbonate, acrylic, polyacrylate, polyester, polysulfone resins, blends or copolymers, or any other suitable transparent plastic material, or a mixture thereof as mentioned in greater detail below. As mentioned above, the substrate may comprise a polycarbonate. In this example, polycarbonates suitable for forming the substrate generally comprise repeating units of the formula:

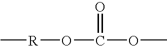

where R is a divalent aromatic radical of a dihydric phenol (e.g., a radical of 2,2-bis(4-hydroxyphenyl)-propane, also known as bisphenol A) employed in the polymer producing reaction; or an organic polycarboxylic acid (e.g. terphthalic acid, isophthalic acid, hexahydrophthalic acid, adipic acid, sebacic acid, dodecanedioic acid, and the like). These polycarbonate resins are aromatic carbonate polymers which may be prepared by reacting one or more dihydric phenols with a carbonate precursor such as phosgene, a haloformate or a carbonate ester, as is well known in the art. One example of a polycarbonate which can be used is LEXAN™, available from General Electric Company.

The substrate may also comprise a polyestercarbonate which can be prepared by reacting a carbonate precursor, a dihydric phenol, and a dicarboxylic acid or ester forming derivative thereof.

The substrate may also comprise a thermoplastic or thermoset material. Examples of suitable thermoplastic materials include polyethylene, polypropylene, polystyrene, polyvinylacetate, polyvinylalcohol, polyvinylacetal, polymethacrylate ester, polyacrylic acids, polyether, polyester, polycarbonate, cellulous resin, polyacrylonitrile, polyamide, polyimide, polyvinylchloride, fluorine containing resins and polysulfone. Examples of suitable thermoset materials include epoxy and urea melamine.

Acrylic polymers are another material from which the substrate may be formed. Acrylic polymers can be prepared from monomers such as methyl acrylate, acrylic acid, methacrylic acid, methyl methacrylate, butyl methacrylate, cyclohexyl methacrylate, and the like. Substituted acrylates and methacrylates, such as hydroxyethyl acrylate, hydroxybutyl acrylate, 2-ethylhexylacrylate, and n-butylacrylate may also be used.

Polyesters may be prepared by the polyesterification of organic polycarboxylic acids (e.g., phthalic acid, hexahydrophthalic acid, adipic acid, maleic acid, terphthalic acid, isophthalic acid, sebacic acid, dodecanedioic acid, and the like) or their anhydrides with organic polyols containing primary or secondary hydroxyl groups (e.g., ethylene glycol, butylene glycol, neopentyl glycol, and cyclohexanedimethanol).

Polyurethanes are another class of materials which can be used to form the substrate. Polyurethanes may be prepared by the reaction of a polyisocyanate and a polyol. Examples of useful polyisocyanates include hexamethylene diisocyanate, toluene diisocyanate, MDI, isophorone diisocyanate, and biurets and triisocyanurates of these diisocyanates. Examples of useful polyols include low molecular weight aliphatic polyols, polyester polyols, polyether polyols, fatty alcohols, and the like.

Examples of other materials from which the substrate may be formed include acrylonitrile-butadiene-styrene, glass, VALOX™ (polybutylenephthalate, available from General Electric Co.), XENOY™ (a blend of LEXAN™ and VALOX™, available from General Electric Co.), and the like.

The substrate can be formed in a conventional manner, for example by injection molding, extrusion, cold forming, vacuum forming, blow molding, compression molding, transfer molding, thermal forming, and the like. The article may be in any shape and need not be a finished article of commerce, that is, it may be sheet material or film which would be cut or sized or mechanically shaped into a finished article. The substrate may be transparent or not transparent. The substrate may be rigid or flexible.

The transparent plastic substrate 14 may include bisphenol-A polycarbonate and other resin grades (such as branched or substituted) as well as being copolymerized or blended with other polymers such as polybutylene terephthalate (PBT), Poly-(Acrylonitrile Butadiene Styrene (ABS), or polyethylene. The transparent plastic substrate 14 may further comprise various additives, such as colorants, mold release agents, antioxidants, and ultraviolet absorbers.

As shown in FIG. 1, a weathering layer 12 is disposed on the transparent plastic substrate 14. In this embodiment, the weathering layer 12 is applied on the surface 18 of substrate 14. The weathering layer preferably includes ultraviolet (UV) absorbing molecules, such as hydroxyphenyltriazine, hydroxybenzophenones, hydroxylphenylbenzotriazoles, hydroxyphenyltriazines, polyaroylresorcinols, and cyanoacrylates among others. In one embodiment, the weathering layer 12 comprises an organic compound. For example, the weathering layer 12 may be one of a polyurethane and a polyurethane-acrylate. In this embodiment, the system having the coating printed and cured on the plastic substrate has a thickness of preferably between about 10 and 65 microns, and has Taber (percent delta haze) of between about 1 and 5 percent delta haze and preferably about 2 percent delta haze.

Polyurethane coatings are considerably less expensive than silicone hardcoats, and they can be applied at relatively high film thicknesses thus providing improved UV-protection for the underlying polycarbonate. Polyurethane coatings were originally defined as products made from polyisocyanates and polyols, but today one defines it more broadly and includes all systems based on a polyisocyanate whether the reaction is with a polyol, a polyamine or with water. This means that a polyurethane (PU) coating may contain urethane, urea, allophanate and biuret linkages. Polyurethane coatings have grown rapidly since they were first introduced decades ago for their highly versatile chemistry and superior properties particularly as to toughness, resistance to abrasion and chemicals while also being flexible and adhering well to all sorts of substrates.

There are about four broad categories of PU technology used in the paint industry, the first three being reactive systems and the fourth covering all systems with no isocyanate reaction during final application.

First, two-component systems comprised of a polyisocyanate and a polyol or polyamine that are mixed just prior to application and curing at room temperature. Next, oven-curing PUs are similar materials to the previous one, except that a blocked isocyanate is used to provide a storage stable one-pack mix with the polyol or polyamine. The isocyanate is then de-blocked when stoved and hence reacts. Third, moisture-cure PUs are one-component, high molecular weight and low free isocyanate containing prepolymers that cure by reacting with moisture from the air to form urea linkages.

The reactive polyurethane paints are generally crosslinked, due either to branched polyols and/or isocyanates, or through formation of allophanate and biuret. Crosslinking, while increasing hardness and abrasion resistance, improves the resistance to water, solvents, weathering and temperature. However, it leads to less advantageous flexibility if too high a level is used. Non-isocyanate reactive formulations encompass TPU-based lacquers, aqueous PU dispersions, urethane oils and alkyds, and also radiation-cured polyurethanes. The latter contain urethane or urea linkages. All just mentioned non-reactive systems have in common that isocyanates do not react during application. This family of PU paints consumes about 35% of all PU for paints.

Popular isocyanates used for clear coatings are IPDI, and TMXDI. They are typically used when UV or light stability is preferred as is the case in topcoats and in many water-based recipes. As far for polyols, their hydroxyl value lies in the 50-300 bracket. Three types are popular: acrylics, polyethers and polyesters. Acrylic and polyester polyols tend to be preferred for harder coats with above average weatherability. The coating performance is also function of the branching level and hydroxyl value of the polyol utilized. It should be noted that one has to select a mix of amines and solvents.

The amine compounds used in paints are in most instances polyoxyalkyleneamines, basically amine-tipped propylene oxide/ethylene oxide copolymers, and amine-teminated chain extenders, such as diethyl toluene diamine (DETDA) or isophorone diamine (IPDA).

Solvents are added to lower the viscosity and improve the processing. However, they should not react with isocyanates and should have less than 500 ppm water content when applied in reactive systems. In one example, three or more solvents are mixed together to help dissolve all components of the coating formulation so as to form a stable emulsion. Commonly utilized solvents are esters, ketones, ether-esters and polar aromatic or aliphatic types whose boiling point ranges from 50° C. to above 150° C.

Non-reactive PU systems typically contain fully formed polymers with urethane or urea linkages, but typically no free isocyanates. For solvent-based lacquers, high molecular weight linear polyurethanes are formed or dissolved in solvents. These PUs are obtained through reacting aliphatic isocyanates (mainly TMXDI or IPDI) with polyester or polyether polyols and chain extenders. The polyurethanes are sprayed and their film is formed by evaporating the solvent. These films are relatively flexible and elastic on top of being relatively resistant to mild solvents.

For radiation curing, this family includes mainly of urethane acrylate coatings that are one-component, low viscosity and hundred percent solids products. They normally are easy to apply and can be rapidly cured by ultraviolet or electron beam energy sources at room temperature. Aromatic grades are used in wood, paper, plastic and ink coats while aliphatic systems are utilized where non-yellowing is preferred, which is the case among other for PVC floor tiles and continuous flooring. The UV curable urethane acrylates are also in adhesives, sealants and potting or encapsulation compounds.

An oligomer is obtained by reacting a prepolymer, obtained from diisocyanate and a polyether or polyester polyol, with a stoichiometric amount of a hydroxyl-containing acrylate such as hydroxypropyl acrylate. Urethane acrylate oligomers are usually blended with some acrylate monomer such as tripropylene glycol diacrylate or trimethylolpropane ethoxylate acrylate as a reactive diluent and a photoinitiator, for UV curing. Benzophenone is a typical photoinitiator which produces free radicals when absorbing UV and then initiates the crosslinking through the acrylate groups. Electron beam radiation (EB) eliminates the need for photoinitiators. The main difference between UV and EB curing is that the electron beams penetrate thick and opaque film layers while UV curing is restricted to clear or thin films.

As mentioned above, the weatherable layer may also include polyurethane acrylates. The use of polyurethane acrylate coatings as weatherable layer for automotive polycarbonate glazing has proven to be favorable as discussed below. In one example, the weatherable coatings may be applied thermally or by dual cure coating methods. The compositions are applied directly on polycarbonate substrates. The process for the production of multilayer coatings for automotive polycarbonate glazing covers the use of these wet coating compositions, along with the plasma layer for the production of polycarbonate glazing system. In relation to examples of the present invention, the term “dual cure coating composition” means a coating composition that is curable by free-radical polymerization on UV irradiation and additionally by thermally induced polymerization.

For thermal cured polyurethane acrylates, a number of hydroxyl-functional acrylic polymers are available that have been designed for formulating urethane coatings. Acrylic urethanes offer several outstanding performance properties. Properties include a high degree of hardness and flexibility, outstanding gloss and color retention, chemical resistance and abrasion resistance. Polyurethane acrylates are generally prepared by a two-step synthesis. An excess of diisocyanate can first react with a polyol(generally a glycol) and then a hydroxyl terminated acrylate. In another procedure, a diisocyanate excess first reacts with the monoalcohol and secondly with the polyol. In yet another procedure, which is a one-step synthesis, all the reactants react simultaneously.

Both thermal and UV cured systems with and without UV absorbers were investigated for adhesion with the plasma layer. Various plasma conditions were investigated. It was possible to achieve adhesion with both systems. However, when a UV absorber was included in both the thermal and the dual cured UV cured systems, the dual cured system with a particular plasma condition, was possible to achieve adhesion and appearance.

The polyurethane-acrylate coating may be cured either thermally or dual cured (UV followed by thermal). For plasma coating (discussed in greater detail below), a plasma is generated via applying a direct-current (DC) voltage to each cathode that arcs to a corresponding anode plate in an argon environment at pressures higher than 150 Torr, e.g., near atmospheric pressure. The near atmospheric thermal plasma then supersonically expands into a plasma treatment chamber in which the process pressure is less than that in the plasma generator, e.g., about 20 to about 100.

In one example, a two component or “2K” polyurethane (2K-PUA) system may, but is not limited to, include a mixture of a polyol resin (Desmophen A870BA from Bayer) and a poly-isocyanate (Desmodur N3390A BA from Bayer) that are mixed prior to application and cured at room temperature. Moreover, a one component or “1K” polyurethane (1K-PUA) system may, but is not limited to, include a blocked isocyanate that is used to provide a storage stable one-pack formulation containing the polyol. After application on the substrate, the isocyanate is de-blocked and reacts with the polyol to form a polyurethane network.

In this example, three 2K-PUA systems were initially evaluated as interlayers for plasma deposition. These systems were chosen to evaluate coatings with a range of glass transition temperatures (i.e. hardness) and to measure the effect of this property on performance. The compositions of these 2K-PUA systems are shown in Table 1.

TABLE 1

| Sample ID | Polyol | Isocyanate |
|---|---|---|
| 670 | Desmophen 670 | Desmodur N3390 |
| 665 | Desmophen A665 | Desmodur N3390 |
| 575 | Desmophen A575 | Desmodur N3390 |

These 2K-PUA systems were spray coated in Leverkusen (Bayer AG) and then plasma coated. The 2K-PUA interlayer thicknesses were 25 microns and the plasma top coat thickness was 2-3 microns. Prior to plasma deposition, samples 670 and 575 were hazy from solvent crazing. After plasma deposition, sample 670 showed some cracking in the plasma topcoat and all three samples were hazy (haze >4%). Plasma coated samples along with 2K coated controls (without plasma topcoat) were subjected to cross-hatch adhesion tests followed by immersion in 65° C. water. The plasma coated and control samples (designated with a C in the table below) initially had showed adhesion, but only the 670-C sample passed the 14 day water soak. The loss in adhesion in these samples occurred between the polycarbonate and the 2K-PUA system based on fourier transform infrared spectroscopy (FTIR) of the surface after adhesion failure. Performance of these samples before and after plasma coating is shown in Table 2.

TABLE 2
Performance of Polyurethane Interlayers

| | | | Water immersion |
|---|---|---|---|
| | Plasma | Taber (percent delta | (days to |
| System | (Y/N) | haze) | adhesionloss) |
| 670 | Y | 45.6 | 5 |
| 670-C | N | N/A | >13 |
| 575 | Y | 20.9 | <5 |
| 575-C | N | N/A | <1 |
| 665 | Y | 6.9 | <5 |
| 665-C | N | N/A | <1 |

Polyurethane Interlayer Screening Experiments: Based on these promising results, a further search was made to identify “harder” polyurethane coatings that could be plasma coated and provide improved scratch resistance compared with the Desmophen A665/Desmodur N3390 coating. Taber abrasion results from these screening experiments are shown in Table 3:

TABLE 3
Evaluation of Polyurethane Systems as Interlayers

| | | | | | Haze | |
|---|---|---|---|---|---|---|
| | | | Plasma | Initial | after | Delta |
| Polyol | Isocyanate | Other | (Y/N) | haze | Taber | haze |
| Desmophen | Desmodur | Xylene/diacetone | N | 0.5 | 59.5 | 59.0 |
| A665 | N3390 | alcohol/isopropanol | | | | |
| | | solvents | | | | |
| Desmophen | Desmophen | Xylene/diacetone | Y | 0.9 | 5.6 | 4.7 |
| A665 | N3390 | alcohol/isopropanol | | | | |
| | | solvents | | | | |
| Desmophen | Desmophen | | N | 1.4 | 59.8 | 58.4 |
| A665 | N3390/Z4470 | | | | | |
| Desmophen | Desmophen | | Y | 0.7 | 4.2 | 3.5 |
| A665 | N3390/Z4470 | | | | | |
| Desmophen | LS-2307 | | N | 1.0 | 54.3 | 53.3 |
| A665 | | | | | | |
| Desmophen | LS-2307 | | Y | 0.7 | 4.2 | 3.5 |
| A665 | | | | | | |
| Desmophen | Desmophen | | Y | 0.9 | 5.4 | 4.5 |
| A665 | Z4470 | | | | | |

The results shown in Table 3 represent the best performance of the respective systems after plasma deposition. Attempts were made to improve and/or duplicate the performance. To address a concern of the variation in polyurethane coating thickness, a single system was used and coated at different coating thicknesses. The results are shown in Table 4. The frosted appearance has been generally attributed to trapped solvents in the coating system and is generally eliminated by post-cure at 100° C. for 2 h.

TABLE 4
Effect of coating thickness on Taber abrasion after plasma deposition

| | | Coating thickness | |
|---|---|---|---|
| Isocyanate | Polyol | (Primer/topcoat) | % delta Haze |
| N3390 | A665 | 20/26 microns | Frosted |
| N3390 | A665 | 20/43 microns | Frosted |
| N3390 | A665 | 20/54 microns | 28.6 |
| N3390 | A665 | 20/63 microns | 14.3 |

Effect of Coating Conditions: This series of experiments was designed to understand the effect of primer thickness, topcoat thickness, flash off time of the primer and topcoat, cure time and temperature of the topcoat, and catalyst addition to the topcoat. The polyurethane system that had given the best performance in Taber testing thus far (A665/Z4470) was chosen for the evaluation and was coated onto substrates supplied by Exatec, plasma coated at Exatec, and then tested at Exatec. Table 5 summarizes results from this evaluation:

TABLE 5
Evaluation of the Effect of Coating Conditions on Product Performance

| | | | | | Water | QUV | |
|---|---|---|---|---|---|---|---|
| | | | | | immersion | (MJ of | |
| | | % Δ | % Δ | Avg. | (days to | exposure | XeWOM |
| | Coating | Haze | Haze | % Δ | adhesion | before | (G155 |
| Sample | modification | (sample 1) | (sample 2) | Haze | toss) | failure) | cycle 2) |
| HVS-50-27-1 | Control | 15.0 | 6.7 | 10.9 | 6 | <1.7 | |
| HVS-50-27-2 | 15′ primer | 2.0 | 5.3 | 4.7 | 14 | <1.7 | <0.617 |
| | flash | | | | | | |
| HVS-50-27-3 | 60′ primer | 2.1 | 4.9 | 3.5 | 1 | <1.7 | <0.617 |
| | flash | | | | | | |
| HVS-50-27-4 | 5 μm primer | 3.5 | 5.7 | 4.6 | 1 | <1.7 | |
| HVS-50-27-5 | 15 μm primer | 2.6 | 3.9 | 3.3 | 1 | <1.7 | <0.617 |
| HVS-50-27-6 | 30′ topcoat | 4.6 | N/A | 4.6 | 1 | <1.7 | |
| | flash | | | | | | |
| HVS-50-27-7 | 30 μm primer | 13.6 | N/A | 13.6 | 1 | <1.7 | |
| HVS-50-27-9 | 0.02% | 3.3 | 3.6 | 3.5 | 14 | <1.7 | |
| | catalyst | | | | | | |
| HVS-50-27-10 | 30′, 80° C. | 4.6 | 2.7 | 3.7 | 1 | <1.7 | <0.617 |
| | topcoat cure | | | | | | |
| HVS-50-27-11 | 90′, 130° C. | 4.2 | 3.0 | 3.6 | 7 | <1.7 | |
| | topcoat cure | | | | | | |
| HVS-50-27-12 | Primerless | 37.9 | 35.0 | 36.5 | 1 | <1.7 | |

Control sample preparation parameters: 10 μm primer thickness, 30′ flash off, 15′80° C. primer cure, 40 μm topcoat thickness, 10° flash off, 10′, 30° C./30′, 130° C. topcoat cure.

Most of the change in haze after Taber abrasion is in the range of 3-5%. Considering the variability in the Taber test itself, one could conclude that most parameters under investigation had no effect on the final scratch resistance after plasma deposition. The exceptions include the sample prepared under control conditions, the sample with a thick primer, and the sample coated with the primeness formulation. These variables contribute to a much higher percent delta haze (>10 percent delta haze).

Other data is available from the water soak test. All samples had initial adhesion (5B, 100%), but only 3 samples survived longer than 1 day in water soak. These samples were the catalyzed sample, the sample with a long cure time for the topcoat, and the system with a short flash off time in the primer. It is possible to conclude from this data that higher degrees of cure in the topcoat improve the performance in water soak. After 1 day in water soak, all the samples were cracked and in some cases began to blister and delaminate. The samples that survived for 7-14 days were cracked by the end of the test.

All samples have been submitted for testing in the QUV—Relative Magnetic Bearing (ASTM 154, cycle 4) and xenon weatherometer (ASTM G155, cycle 2). The available data suggests that the polyurethane samples still delaminate after minimal exposure in both the Xenon WOM and the QUV-A. The samples from QUV were severely cracked after exposure but the samples from the XeWOM were unchanged except for the loss of adhesion. Delamination occurred between the plasma coating and the polyurethane.

New Coating Formulations: Next, a series of experiments was designed to test new coating formulations for their performance in Taber abrasion testing after plasma deposition. Results from these tests are shown in Table 6:

TABLE 6
Evaluation of New Coating Formulations

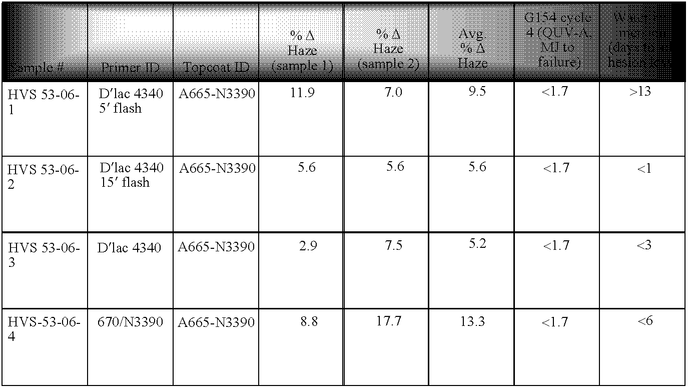

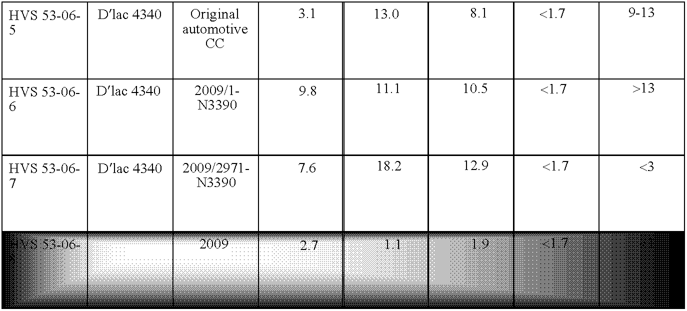

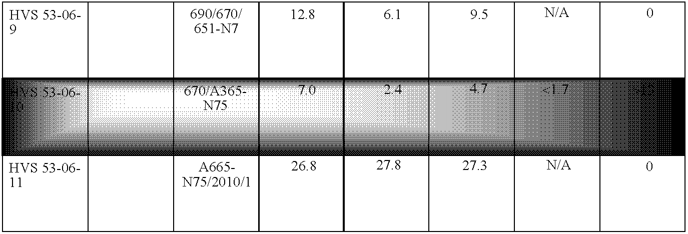

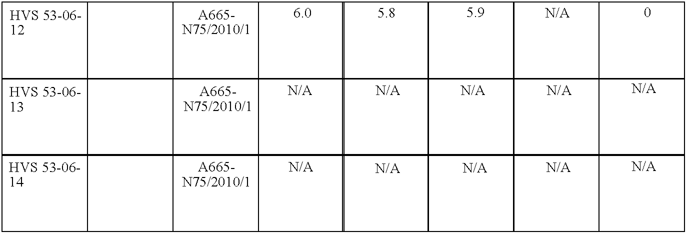

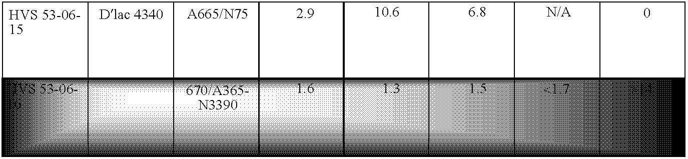

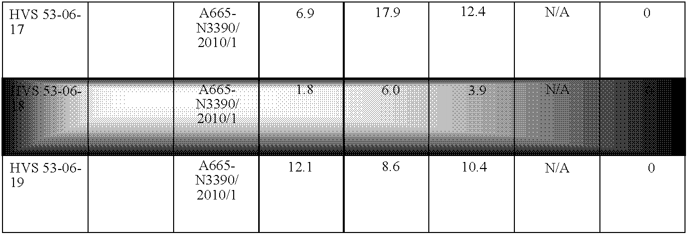

Results from these evaluations provided the basis for selection of a few candidates for further evaluation. The data from this series of coatings shows that the goal of reaching 2% delta haze is possible, but that overall consistency continues to be a problem. The lack of consistency is evident when sample #1 and sample #2 from each formulation are compared. Two (2) samples were cut from a plaque coated with each formulation and were tested for Taber abrasion. In most cases, sample #1 and sample #2 were significantly different. Adhesion was also a problem for several primeness formulations. Several samples maintained adhesion after 13 days in water soak, but only one system performed well in taber abrasion and survived 13 days in water soak, A670/A365-N3390. Based on this data, samples that do not require a primer and also have a Taber in the range of 2% (highlighted in the Table above) were chosen for further evaluation. Specifically, the systems A665-N3390/2020/1, A670/A365-N3390, 2009, and 670/A365-N75.

Replication: The four systems chosen from the above evaluations were spray coated again onto polycarbonate panels from Exatec, plasma coated and retested to confirm the results from previous testing. Each formulation was coated onto 2 panels each, a new formulation was added to the evaluation, and all were tested for performance in Taber (4 samples for each formulation), water immersion (2 samples for each formulation), and QUV (2 samples from each formulation). The results from Taber and water immersion (Taber #2 and WI #2) are shown in Table 7 compared with the data from previous testing (Taber #1 and WI #1).

TABLE 7
Replicate work with formulations selected from Table 6.

| | Taber #1 | Taber #2 | WI #1 (days to | WI #2 |
|---|---|---|---|---|
| | (percent delta | (percent | adhesion | (days to |
| | haze) see | delta | failure) see | adhesion |
| Sample ID | Table 6 | haze) | Table 6 | failure) |
| HVS 53-6-8 | 1.9 | 18.4 | <1 | <5 |
| HVS 53-6-10 | 4.7 | 3.9 | >13 | >5 |
| HVS 53-6-16 | 1.5 | 5.0 | >13 | >5 |
| HVS 53-6-18 | 3.9 | 14.6 | 0 | <5 |
| New (HVS 53- | N/A | 3.1 | N/A | <10 |
| 16-5) | | | | |

Reproducibility of Taber performance less than 2 percent delta haze was an issue, but the water immersion results were consistent with previous work. From this re-evaluation the systems HVS 53-6-10 and HVS 53-6-16 were studied in more detail.

Experiments: Polycarbonate substrates were sent to Bayer for coating with the polyurethane systems. These substrates were spray coated at Bayer and then sent to Exatec where they were plasma coated. The samples were then cut into smaller pieces and tested.

Some evaluations of polyurethane coatings as interlayers were complicated by residual solvents trapped within the coating prior to plasma deposition. The samples came out of the plasma chamber nearly opaque (frosted) and of less advantageous quality.

To confirm that the problems were in fact due to residual solvent, retains (samples that were not plasma coated) were post-dried in an oven at 100° C. for 7 hours and then plasma coated 2 weeks later. Coatings based on Desmophen A665/Desmodur N3390 and Desmophen A665/Desmodur LS-2307 came out much better than before but Desmophen A665/Desmodur N3390/Z4470 was unchanged. It became general practice to post-cure all samples prior to plasma deposition until the cure conditions were investigated. After this investigation, post treatment was no longer required.

For the weatherable coating systems, three systems at an approximate thickness of 20 micron were tested under four different plasma conditions as follows: acrylate-UV cured only; polyurethane acrylate dual cured; and polyurethane acrylate thermal cured. As far as plasma coating systems for the uncoated plastic substrate, a 1^{st} coating layer (1A) is then deposited using the conditions mentioned in the Table below. The deposition of the 1^{st} coating layer (1A) is followed by the deposition of a 2^{nd} coating layer (2A) using an arc current of about 37 Amps, a reactive reagent flow of about 150 sccm, and an oxygen (O₂) flow of about 800 sccm.

TABLE 8

| Plasma | | Arc | | |
|---|---|---|---|---|
| Run | PH | current | D4 | O2 |
| A | 150 | 31 | 100 | 300 |
| B | 200 | 31 | 100 | 300 |
| C | 200 | 31 | 100 | 0 |
| D | 425 | 37 | 125 | 300 |

As for results, after plasma deposition, the entire coating system was tested by the Water immersion adhesion test (see Table 9 below).

TABLE 9

| | | | |
|---|---|---|---|
| Water immersion adhesion 65 C. | Day 1 | Day 5 | Day 12 |

Plasma condition A

| | | | |
|---|---|---|---|
| 1 | Acrylate | UV cured | 82D |
| 2 | Urethane acrylate A | Dual cure | 3D |
| 3 | Urethane acrylate B | Thermal cured | 0D |

Plasma conditionB

| | | | |
|---|---|---|---|
| 1 | Acrylate | UV cured | 0D-PL |
| 2 | Urethane acrylate A | Dual cure | 0D-PL |
| 3 | Urethane acrylate B | Thermal cured | 0D |

Plasma condition C

| | | | | | |
|---|---|---|---|---|---|
| 1 | Acrylate | UV cured | 45D-PI | | |
| 2 | Urethane acrylate A | Dual cure | 99B | 99B | 99B |
| 3 | Urethane acrylate B | Thermal cured | 99B | 99C | 99C |

Plasma condition D

| | | | | | |
|---|---|---|---|---|---|
| 1 | Acrylate | UV cured | 88D | | |
| 2 | Urethane acrylate A | Dual cure | 99B | 99B | 97C |
| 3 | Urethane acrylate B | Thermal cured | 99B | 98B | 99C |

The polyurethane-acrylate polymers were thermal cured and Dual Cured (UV followed by thermal). The thickness ranged from 15-30 micron in this example. The application was drawdown or spray applied (see Table 10 below).

TABLE 10

| | | | | Film Build |
|---|---|---|---|---|
| Sample | Curing Mechanism | Ultraviolet Absorber/HALS Package | Application | in Microns |
| 1 | Thermal | None | draw down | 15 |
| 2 | Thermal | None | draw down | 25 |
| 3 | Thermal | None | spray | 33 |
| 4 | Dual cure UV/Thermal Clear | None | draw down | 15 |
| 5 | Dual cure UV/Thermal Clear | None | draw down | 25 |
| 6 | Dual cure UV/Thermal Clear | None | spray | 33 |
| 7 | Thermal Clear UVA/HALS(1) | Ultraviolet Absorber/HALS Package 1 | draw down | 15 |
| 8 | Thermal Clear UVA/HALS(1) | Ultraviolet Absorber/HALS Package 1 | draw down | 25 |
| 9 | Thermal Clear UVA/HALS(1) | Ultraviolet Absorber/HALS Package 1 | spray | 30 |
| 10 | Dual cure UV/Thermal ClearUVA/HALS(1) | Ultraviolet Absorber/HALS Package 1 | draw down | 15 |
| 11 | Dual cure UV/Thermal ClearUVA/HALS(1) | Ultraviolet Absorber/HALS Package 1 | draw down | 25 |
| 12 | Dual cure UV/Thermal ClearUVA/HALS(1) | Ultraviolet Absorber/HALS Package 1 | spray | 30 |
| 13 | Thermal Clear UVA/HALS(2) | Ultraviolet Absorber/HALS Package 2 | draw down | 15 |
| 14 | Thermal Clear UVA/HALS(2) | Ultraviolet Absorber/HALS Package 2 | draw down | 25 |
| 15 | Thermal Clear UVA/HALS(2) | Ultraviolet Absorber/HALS Package 2 | spray | 30 |
| 16 | Dual cure UV/Thermal Clear UVA/HALS(2) | Ultraviolet Absorber/HALS Package 2 | draw down | 15 |
| 17 | Dual cure UV/Thermal Clear UVA/HALS(2) | Ultraviolet Absorber/HALS Package 2 | draw down | 25 |
| 18 | Dual cure UV/Thermal Clear UVA/HALS(2) | Ultraviolet Absorber/HALS Package 2 | spray | 30 |

As for plasma coating systems for the uncoated plastic substrate A, 1^{st} coating layer (1A) is then deposited using the plasma conditions shown in the Table below. The deposition of the 1^{st} coating layer (1A) is followed by the deposition of a 2^{nd} coating layer (2A) using an arc current of about 37 Amps, a reactive reagent flow of about 150 sccm, and an oxygen (O₂) flow of about 800 sccm.

TABLE 11

| Plasma | | | Arc | |
|---|---|---|---|---|
| Run | PH | O2 | current | D4 |
| 1 | 150 | 300 | 31 | 100 |
| 2 | 200 | 300 | 31 | 100 |
| 3 | 200 | 0 | 31 | 100 |
| 4 | 200 | 150 | 31 | 100 |

For results, each of the coating systems was tested for adhesion after water immersion, followed by appearance for clarity and cracking behavior. Only the following three systems listed in Table 12 below passed adhesion using the following plasma condition.

A 1^{st} coating layer (HC1B) was deposited using an arc current of about 31 Amps, a reactive reagent flow of about 100 sccm, and an oxygen (O₂) flow of about 0 sccm. The deposition of the 1^{st} coating layer (HC1B) is followed by the deposition of a 2^{nd} coating layer (HC2B) using an arc current of about 37 Amps, a reactive reagent flow of about 150 sccm, and an oxygen (O₂) flow of about 800 sccm.

TABLE 12

| Plasma | | UVA/HALS | Coating | Film | Day 10 | | |
|---|---|---|---|---|---|---|---|
| condition | Description | package | Application | Thickness | Adhesion | Cracking | Clarity |
| 3 | Dual cure UV/thermal | None | Draw Down | 15 | 99B | Very light | clear |
| 3 | Dual cure UV/thermal | None | Spray | 30 | 100A | None | clear |
| 3 | Dual cure UV/thermol | UVA/HALS | Spray | 30 | 80D | Very light | clear |
| | | package 1 | | | | | |

In this example, the weathering layer 12 has a predetermined glass transition temperature (Tg). The glass transition temperature of the weathering layer is preferably greater than about 60° C. When different polyurethane and polyurethane-acrylate resins are blended together in an ink formulation, the resulting glass transition temperature of the system should meet the range described above. However, one or more polyurethane or polyurethane-acrylate in the mixture may exhibit an individual Tg value that is outside the specified range.

Typically a blend of resins will result in a Tg_{blend} that is situated between the individual Tg values exhibited by each of the resins present in the blend. This Tg_{blend} is dependent upon the amount of each resin present in the blended ink as shown in Equation 1 below, where W_{A} and W_{B} are the weight fractions of each resin that individually exhibit a glass transition temperature of Tg_{A} and Tg_{B}, respectively. For a weathering layer comprising a blend of resins, the ratio of 1/Tg_{blend} exhibited by this blend should be less than about 0.002985 with less than about 0.0029239 being especially preferred. T should be in Kelvin. T should be in Kelvin using the following equation:

1/Tg_{blend}=(W_{A}/Tg_{A})+(W_{B}/Tg_{A}). (1)

The glass transition temperature (Tg) of an amorphous material generally represents the temperature below which molecules are relatively immobile or have relatively negligible mobility. For polymers, physically, this means that the associated polymeric chains become substantially motionless. In other words, the translational motion of the polymeric backbone, as well as the flexing or uncoiling of polymeric segments is inhibited below the glass transition temperature. On a larger scale, these polymers exhibit a hard or rigid condition. Above its glass transition temperature, these polymers will become more flexible or “rubbery”, thereby exhibiting the capability of larger elastic or plastic deformation without fracture. This transition occurs due to the polymeric chains becoming untangled, gaining more freedom to rotate and slip past each other. The Tg is usually applicable to amorphous phases and is commonly applicable to glasses and plastics. Factors such as heat treatment and molecular re-arrangement, vacancies, induced strain and other factors affecting the condition of a material may affect the Tg. The Tg is dependent on the viscoelastic properties of the material, and thus varies with the rate of applied load.

With polymers, the Tg is often expressed as the temperature at which the Gibb's Free Energy is such that the activation energy for the cooperative movement of about 50 elements of the polymer is exceeded. This allows molecular chains to slide past each other when a force is applied. From this definition, the introduction of side chains and relatively stiff chemical groups (e.g., benzene rings) will interfere with the flowing process and hence increase the Tg. With thermoplastics, the stiffness of the material will drop due to this effect.

The most common method to determine the Tg of a polymeric system is to monitor the variation that occurs in a thermodynamic property, such as modulus, as a function of temperature. As shown in FIG. 2, the modulus (E) of a polymeric material decreases as temperature increases. When the glass transition temperature has been reached, the modulus remains relatively constant until the material begins to flow. The region over which the modulus remains constant is called the “rubber” plateau. Many other means to measure the glass transition temperature of a polymeric material, such as thermal mechanical analysis (TMA) or differential scanning calorimetry (DSC) to name a few, are common analytical methods known to those skilled in the art of polymer synthesis.

The Tg exhibited by a polymer system can be significantly decreased by the addition of a plasticizer into the polymer matrix. The small molecules of the plasticizer may embed themselves between the polymeric chains, thereby, spacing the chains further apart (i.e., increasing the free volume) and allowing them to move against each other more easily.

A variety of additives may be added to the weathering layer 12, such as colorants (tints), rheological control agents, mold release agents, antioxidants, and IR absorbing or reflecting pigments, among others. The weathering layer 12, including any multiple interlayers, may be extruded or cast as thin films or applied as discrete coatings. Any coatings that comprise the weathering layer may be applied by dip coating, flow coating, spray coating, curtain coating, or other techniques known to those skilled in the art. The plastic glazing system 10 further comprises an abrasion resistant layer 22 disposed on layer 20 on surface 16 of the plastic panel (e.g., towards the “B” or inner surface of the window).

An abrasion-resistant layer 34 is applied to the “A” or outer surface 18 of the window on top of the weathering layer 12. The abrasion resistant layer 34 is compatible with the weathering layer 12 to affect a Taber abrasion performace of between about 1 and 5 percent delta haze, and preferably 2 percent delta haze. The abrasion resistant layer 34 also functions to increase the scratch resistance of the layered article and typically comprises a plasma polymerized organosilicon material containing silicon, hydrogen, carbon, and oxygen, generally referred to as SiOₓC._{y}H_{z}. Typically, 0.5<x<2.4, 0.3<y<1.0, and 0.7<z<4.0. The abrasion resistant layer typically has a thickness of 0.5-5.0 microns, more typically 1.0-4.0 microns, more typically 2-3 microns.

The abrasion resistant layer 34 may be substantially similar or different to abrasion resistant layer 22 in either chemical composition or structure. One or both abrasion-resistant layers, 22 and 34, may contain UV absorbing or blocking additives. Both abrasion resistant layers, 22 and 34, may be either comprised of one layer or a combination of multiple interlayers of variable composition. The abrasion-resistant layers, 22 and 34, may be applied by any vacuum deposition technique known to those skilled in the art, including but not limited to plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and any known sol-gel coating process.

According to exemplary embodiments of the invention, PECVD is used to initiate the polymerization and oxidation reactions of an organosilicon compound and excess oxygen employing a power density ranging from 10⁶ to 10⁸ joules/kilogram (J/Kg). Higher power densities may produce films which easily crack while lower densities may produce films which are less abrasion resistant. Typically, oxygen is present in an amount in excess of that stoichometrically necessary to oxidize all silicon and carbon in the organosilicon compound.

Power density is the value of W/FM wherein W is an input power applied for plasma generation expressed in J/sec, F is the flow rate of the reactant gases expressed in moles/sec, and M is the molecular weight of the reactant in Kg/mole. For a mixture of gases the power density can be calculated from W/ΣFᵢMᵢ wherein “i” indicates the “ith” gaseous component in the mixture. By practicing within the power density range and with excess oxygen a single polymerized protective layer can be formed on the substrate surface, the layer being substantially non-cracking, clear, colorless, hard and strongly adhered thereto.

In one embodiment of the present invention, a specific type of PECVD process comprising an expanding thermal plasma reactor is preferred. This specific process (called hereafter as an expanding thermal plasma PECVD process) is described in detail in U.S. patent application Ser. No. 10/881,949 (filed Jun. 28, 2004) and U.S. patent application Ser. No. 11/075,343 (filed Mar. 8, 2005), the entirety of both being hereby incorporated herein by reference. In an expanding thermal plasma PECVD process, a plasma is generated via applying a direct-current (DC) voltage to a cathode that arcs to a corresponding anode plate in an inert gas environment at pressures higher than 150 Torr, e.g., near atmospheric pressure. The near atmospheric thermal plasma then supersonically expands into a plasma treatment chamber in which the process pressure is less than that in the plasma generator, e.g., about 20 to about 100 mTorr.

The reactive reagent for the expanding thermal plasma PECVD process may comprise, for example, octamethylcyclotetrasiloxane (D4), tetramethyldisiloxane (TMDSO), hexamethyldisiloxane (HMDSO), vinyl-D4 or another volatile organosilicon compound. The organosilicon compounds are oxidized, decomposed, and polymerized in the arc plasma deposition equipment, typically in the presence of oxygen and an inert carrier gas, such as argon, to form an abrasion resistant layer.

The abrasion resistant layers 22 and 34 may be comprised of an inorganic compound. For example, the abrasion resistant layers 22 and 34 may be comprised of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture or blend thereof. Preferably, the abrasion resistant layers, 22 and 34, are comprised of a composition ranging from SiOₓ to SiOₓC_{y}H_{z} depending upon the amount of carbon and hydrogen atoms that remain in the deposited layer.

One embodiment of the present invention includes a method of making a plastic glazing system having enhanced yield. In this embodiment, the transparent plastic substrate preferably comprises bisphenol-A polycarbonate and other resin grades (such as branched or substituted) as well as being copolymerized or blended with other polymers such as polybutylene terephthalate (PBT), Poly-(Acrylonitrile Butadiene Styrene (ABS), or polyethylene. The substrate preferably is formed into a window, e.g., vehicle window, from plastic pellets or sheets through the use of any known technique to those skilled in the art, such as extrusion, molding, which includes injection molding, blow molding, and compression molding, or thermoforming, which includes thermal forming, vacuum forming, and cold forming. It is to be noted that the forming of a window using plastic sheet may occur prior to printing, after printing, or after application of the primer and top coat without falling beyond the scope or spirit of the present invention.

In this embodiment, the method further comprises applying the weathering layer on the first surface of the substrate. The weathering layer is an ink comprising one of the polyurethanes and polyurethane-acrylates mentioned above. The system has a thickness of preferably between about 15 and 65 microns, and has Taber (percent delta haze) of between about 1 and 5 percent delta haze and preferably about 2 percent delta haze.

In this embodiment, the method further comprises drying the weathering layer on the substrate at room temperature for about 20 minutes and curing the weathering layer on the substrate at between about 90 and 100° C. for about 30 minutes. The method further comprises applying a weatherable layer to the second surface of the plastic substrate using a flow, dip, or spray coating process.

In this example, the method further includes applying abrasion resistant layers on top of the weatherable layer. The abrasion resistant layers are comprised of a composition ranging from SiOₓ to SiOₓC_{y}H_{z}. The abrasion resistant layers are deposited using at least one of the follow processes: plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and any known sol-gel coating process with the expanding thermal plasma PECVD process being preferred.

While the present invention has been described in terms of preferred embodiments, it will be understood, of course, that the invention is not limited thereto since modifications may be made to those skilled in the art, particularly in light of the foregoing teachings.

1. A plastic glazing system having weatherable coating for automotive windows, the system comprising:
a transparent plastic substrate comprising an inner surface and an outer surface;
a first weathering layer disposed on the outer surface of the substrate, the weathering layer comprises one of a polyurethane and a polyurethane-acrylate, the first weathering layer having a predetermined glass transition temperature; and
a first abrasion-resistant layer disposed on the first weathering layer, the first abrasion-resistant layer being compatible with the one of a polyurethane and a polyurethane-acrylate.

2. The system of claim 1 wherein the first abrasion-resistant layer is compatible with the one of the polyurethane and the polyurethane-acrylate to affect a Taber abrasion performance of the system of between about 1 and 5 percent delta haze.

3. The system of claim 1 wherein the Taber abrasion performance of the system is about 2 percent delta haze.

4. The system of claim 1 wherein the weathering layer is coated by dual cure coating and has a glass transition temperature of greater than about 60 degrees Celsius.

5. The system of claim 1 wherein the weathering layer comprises a mixture of resins whose sum of W/Tg ratios is less than about 0.002985.

6. The system of claim 1 further comprising:
a second weathering layer deposited on the inner surface; and
a second abrasion-resistant layer deposited on the second weathering layer.

7. The system of claim 6 wherein the second abrasion-resistant layer deposited on the second weathering layer is substantially similar to the first abrasion-resistant layer deposited on the first weathering layer.

8. The system of claim 1 wherein the polyurethane includes one of 1K and 2K polyurethane systems.

9. The system of claim 1 wherein the weathering layer comprises an ultraviolet absorbing molecule for absorption of UV radiation.

10. The system of claim 1 wherein the transparent plastic substrate comprises one of a polycarbonate resin, acrylic resin, polyacrylate resin, polyester resin, polysulfone resin, and copolymers or mixtures thereof.

11. The system of claim 1 wherein the first abrasion resistant layer applied on the first weathering layer comprises aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicono oxy-carbide, silicon carbide, tantalum oxide, titanium oxide, tin oxide, indium tin oxide, yttrium oxide, zinc oxide, zinc selenide, zinc sulfide, zirconium oxide, or zirconium titanate, or a mixture thereof.

12. The system of claim 1 wherein the first weathering layer comprises an organic compound and the first abrasion-resistant layer comprises an inorganic compound, the first weathering layer being compatible with the first abrasion-resistant layer.

13. The system of claim 12 wherein the first abrasion-resistant layer adheres to the first weathering layer.

14. A method of making a plastic glazing system, the method comprising:
applying a first weathering layer on a transparent plastic substrate, the first weathering layer comprising one of a polyurethane and a polyurethane-acrylate, the first weathering layer having a predetermined glass transition temperature; and
applying a first abrasion-resistant layer disposed on the first weathering layer, the first abrasion-resistant layer being compatible with the one of a polyurethane and a polyurethane-acrylate.

15. The method of claim 14 further comprising:
applying a second weathering layer on the transparent plastic substrate opposite the first weathering layer;
applying a second abrasion-resistant layer on the second weathering layer; and
drying the first and second weathering layers at between about 90 and 100° C. for at least about 30 minutes.

16. The method of claim 14 wherein the first abrasion-resistant layer is compatible with the one of the polyurethane and the polyurethane-acrylate to affect a Taber abrasion performance of the system of between about 1 and 5 percent delta haze.

17. The method of claim 14 wherein the Taber abrasion performance of the system is about 2 percent delta haze.

18. The method of claim 15 wherein the first and second weathering layer have a glass transition temperature of greater than about 60 degrees Celsius.

19. The method of claim 14 wherein the weathering layer comprises a mixture of resins whose sum of W/Tg ratios is less than about 0.002985.

20. The method of claim 14 wherein the polyurethane includes one of 1K and 2 K polyurethane systems.
